(19) United States
(12) Patent Application Publication
(10) Pub. No.: US 2023/0003654 A1
(43) Pub. Date: Jan. 5, 2023

(54) DETECTION SUBSTRATE, DETECTION SYSTEM, AND DETECTION METHOD OF SURFACE-ENHANCED RAMAN SCATTERING

(71) Applicant: National Tsing Hua University, Hsinchu City (TW)

(72) Inventors: Kuan-Hung Chen, Hsinchu City (TW); Ping-Han Chen, Hsinchu City (TW); Fan-Gang Tseng, Hsinchu City (TW)

(73) Assignee: National Tsing Hua University, Hsinchu City (TW)

(21) Appl. No.: 17/494,838

(22) Filed: Oct. 6, 2021

(30) Foreign Application Priority Data
Jul. 2, 2021 (TW) 110124473

(51) Int. Cl. G01N 21/65

(52) U.S. Cl. CPC G01N 21/658

(57) ABSTRACT

A detection substrate of surface-enhanced Raman scattering including a substrate, pillar structures, and target-analyte linking substances are provided. The pillar structures are disposed on the substrate. The pillar structure has a Raman active surface. The ratio of a maximum length of the top-view pattern of the pillar structures to a gap between the adjacent pillar structures ranges from 0.2 to 0.4. The target-analyte linking substances are disposed on the pillar structures.

### CROSS-REFERENCE TO RELATED APPLICATION

This application claims the priority benefit of Taiwan application serial no. 110124473, filed on Jul. 2, 2021. The entirety of the above-mentioned patent application is hereby incorporated by reference herein and made a part of this specification.

### BACKGROUND

### Technical Field

The disclosure relates to a detection substrate, a detection system, and a detection method, particularly to a detection substrate, a detection system, and a detection method of surface-enhanced Raman scattering (SERS).

### Description of Related Art

When screening for pathogens of diseases such as coronavirus disease 2019 (COVID-19), the optimal treatment time is often delayed by the complicated detection process and the long detection time. Therefore, it is the goal of current development to carry out the pathogen screening in a convenient and rapid way.

### SUMMARY

The present disclosure provides a detection substrate, a detection system, and a detection method of surface-enhanced Raman scattering (SERS), which facilitate pathogen screening in a convenient and rapid way.

The present disclosure provides a detection substrate of SERS, including a substrate, a plurality of pillar structures, and a plurality of target-analyte linking substances. The pillar structures are disposed on the substrate. The pillar structures have a Raman active surface. The ratio of a maximum length of the top-view pattern of the pillar structures to a gap between the adjacent pillar structures ranges from 0.2 to 0.4. The target-analyte linking substances are disposed on the pillar structures.

According to an embodiment of the present disclosure, in the detection substrate of SERS mentioned above, the material of the substrate is, for example, plastic.

According to an embodiment of the present disclosure, in the detection substrate of SERS mentioned above, the plastic is, for example, polycarbonate (PC).

According to an embodiment of the present disclosure, in the detection substrate of SERS mentioned above, the substrate and the pillar structure may be integrally formed.

According to an embodiment of the present disclosure, in the detection substrate of SERS mentioned above, the pillar structures may be ordered pillar structures.

According to an embodiment of the present disclosure, in the detection substrate of SERS mentioned above, the target-analyte linking substances include an antibody.

The present disclosure provides a detection system of SERS, including a Raman spectrometer, a detection substrate, and a liquid sample. The detection substrate includes a substrate, a plurality of pillar structures, and a plurality of first target-analyte linking substances. The pillar structures are disposed on the substrate. The pillar structures have a Raman active surface. The ratio of a maximum length of the top-view pattern of the pillar structures to a gap between the adjacent pillar structures ranges from 0.2 to 0.4. The first target-analyte linking substances are disposed on the pillar structures. The liquid sample includes a liquid solution, a sample, a plurality of particles, a plurality of second target-analyte linking substances, and a plurality of Raman tags. The sample is in the liquid solution. The particles are also in the liquid solution. The second target-analyte linking substances are disposed on the particles. And the Raman tags are provided on the particles.

According to an embodiment of the present disclosure, in the detection system of SERS mentioned above, the material of the substrate is, for example, plastic.

According to an embodiment of the present disclosure, in the detection system of SERS mentioned above, the substrate and the pillar structures may be integrally formed.

According to an embodiment of the present disclosure, in the detection system of SERS mentioned above, the pillar structures may be ordered pillar structures.

According to an embodiment of the present disclosure, in the detection system of SERS mentioned above, the first target-analyte linking substances may be different from the second target-analyte linking substances.

According to an embodiment of the present disclosure, in the detection system of SERS mentioned above, the first target-analyte linking substances and the second target-analyte linking substances may be linked to different binding sites on a target analyte.

According to an embodiment of the present disclosure, in the detection system of SERS mentioned above, the first target-analyte linking substances and the second target-analyte linking substances may respectively include an antibody, and a target analyte may include an antigen.

According to an embodiment of the present disclosure, in the detection system of SERS mentioned above, the particles may be nanoparticles.

According to an embodiment of the present disclosure, in the detection system of SERS mentioned above, the particles may be Raman active particles.

The present disclosure provides a detection method of SERS, which includes the following steps. A detection substrate is provided, wherein: the detection substrate includes a substrate; a plurality of pillar structures, and a plurality of first target-analyte linking substances; the pillar structures are disposed on the substrate; the pillar structures have a Raman active surface; and the first target-analyte linking substances are disposed on the pillar structures. A liquid sample is provided on the detection substrate, wherein: the liquid sample includes a liquid solution, a sample, a plurality of particles, a plurality of second target-analyte linking substances, and a plurality of Raman tags; the sample is in the liquid solution; the particles are also in the liquid solution; the second target-analyte linking substances are disposed on the particles; and the Raman tags are provided on the particles. After the liquid sample is provided on the detection substrate, a Raman signal of the sample is measured under conditions where the liquid solution is present.

According to an embodiment of the present disclosure, in the detection method of SERS mentioned above, after providing the liquid sample on the detection substrate, the Raman signal of the sample may be measured without cleaning.

According to an embodiment of the present disclosure, in the detection method of SERS mentioned above, under conditions where an intensity of the Raman signal of the sample reaches a specific Raman-signal intensity, it is determined that the sample includes a target analyte, and under conditions where the intensity of the Raman signal of the sample does not reach the specific Raman-signal intensity, it is determined that the sample does not include the target analyte.

According to an embodiment of the present disclosure, in the detection method of SERS mentioned above, the ratio of the maximum length of the top-view pattern of the pillar structures to the gap between the adjacent pillar structures may range from 0.2 to 0.4.

According to an embodiment of the present disclosure, in the detection method of SERS mentioned above, the material of the substrate is, for example, plastic.

Based on the above, in the detection substrate of SERS and the detection system of SERS proposed by the present disclosure, since the ratio of the maximum length of the top-view pattern of the pillar structures to the gap between the adjacent pillar structures is in the range of 0.2 to 0.4, it may effectively enhance the intensity of the Raman signal and facilitate the pathogen screening in a convenient and rapid way. In addition, the detection system of SERS proposed by the present disclosure provides a solution of sandwich capture technique. That is, the target analyte is captured by linking the first target-analyte linking substances on the pillar structures and the second target-analyte linking substances on the particles respectively to the target analyte, which increases specificity and sensitivity.

Furthermore, in the detection method of SERS proposed in the present disclosure, the first target-analyte linking substances on the pillar structures, the second target-analyte linking substances on the particles, and the sample may undergo a one-pot reaction. Under conditions where the sample includes the target analyte, the target analyte is bound to the first target-analyte linking substances on the pillar structures and the second target-analyte linking substances on the particles. In this way, as the particles combined with the target object are close to the hot spot above the detection substrate, a clear Raman signal is generated by the Raman tags on the particles to perform the pathogen screening. In addition, since the SERS measurement is highly related to distance, particles that are not bound to the target object are suspended on the surface of the liquid sample and thus do not affect the measurement result. In this way, after the liquid sample is provided on the detection substrate, the Raman signal of the sample may be measured under conditions where the liquid solution is present (for example, without cleaning), and therefore, the pathogen screening may be carried out in a convenient and rapid way without being affected by background noise (e.g., the particles that are not bound to the target analyte).

In order to make the above-mentioned features and advantages of the present disclosure more comprehensible, the following specific embodiments are described in detail in conjunction with the accompanying drawings.

### BRIEF DESCRIPTION OF THE DRAWINGS

FIG. 1 is a schematic diagram of a detection substrate of SERS according to an embodiment of the present disclosure.

FIG. 2 is a top view of the detection substrate of the SERS in FIG. 1.

FIG. 3 is a schematic diagram of a detection system of SERS according to an embodiment of the present disclosure.

FIG. 4 is a flowchart of a detection method of SERS according to an embodiment of the present disclosure.

### DESCRIPTION OF THE EMBODIMENTS

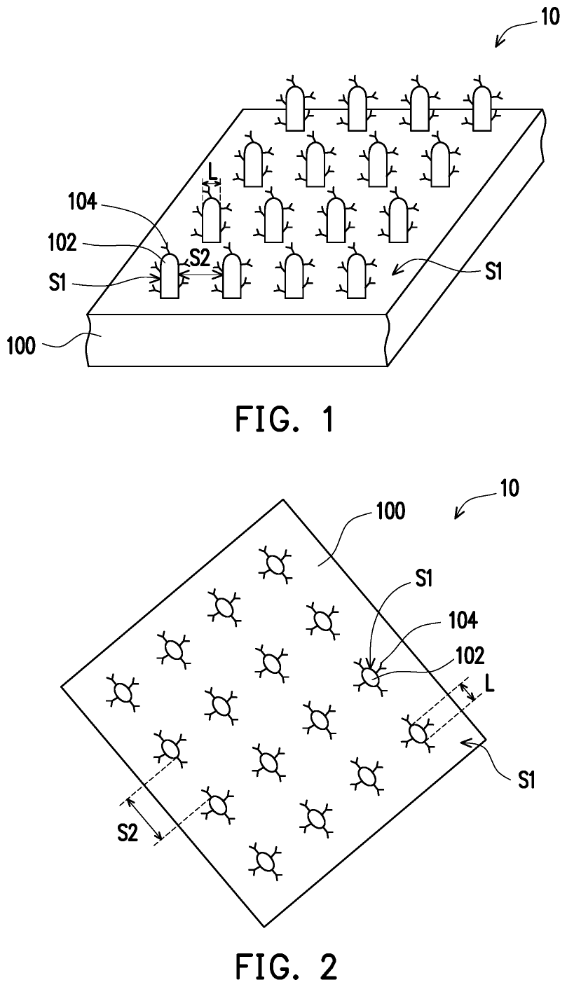

FIG. 1 is a schematic diagram of a detection substrate of SERS according to an embodiment of the present disclosure. FIG. 2 is a top view of the detection substrate of the SERS in FIG. 1.

In FIG. 1 and FIG. 2, a detection substrate 10 of SERS includes a substrate 100, a plurality of pillar structures 102, and a plurality of target-analyte linking substances 104. The pillar structures 102 are disposed on the substrate 100. In some embodiments, the pillar structures 102 may be ordered pillar structures to thereby enhance the intensity of the Raman signal. That is, the pillar structures 102 may be disposed in a regular fashine. In some embodiments, the material of the substrate 100 and the material of the pillar structures 102 may be the same or different. The materials of the substrate 100 and the pillar structures 102 are each plastic in this embodiment, but the disclosure is not limited thereto. The plastic is, for example, polycarbonate, but the disclosure is not limited thereto. In this embodiment, the material of the substrate 100 and the material of the pillar structures 102 are polycarbonate as an example, but the disclosure is not limited thereto. In some embodiments, the pillar structures 102 may be nanoscale nano-pillars.

In some embodiments, the substrate 100 and the pillar structures 102 may be integrally formed, but the present disclosure is not limited thereto. In some embodiments, the substrate 100 and the pillar structures 102 may be fabricated by optical disc manufacturing technology, but the disclosure is not limited thereto. In some embodiments, the method for fabricating the substrate 100 and the pillar structures 102 may include imprinting the substrate 100 by using a template with a predetermined pattern to form the pillar structures 102 on the substrate 100, so as to form the substrate 100 and the pillar structures 102 integrally. However, in other embodiments, it is possible that the substrate 100 and the pillar structures 102 are not integrally formed, and the substrate 100 and the pillar structures 102 are connected by film adherence, film self-assembly, etc.

The pillar structures 102 have a Raman active surface S1. In this embodiment, “Raman active surface” refers to a surface adapted to enhance the Raman signal. For example, the Raman active surface S1 may be a rough metal surface. The material of the rough metal surface is, for example, silver, gold, platinum, nickel, copper, or a combination thereof. In some embodiments, the material of the rough metal surface may be adhered to the pillar structures 102 by using an adhesive metal (not shown in the drawings). The material to which the metal is adhered is, for example, titanium or chromium. In some embodiments, the substrate 100 may also have the Raman active surface S1.

The ratio of a maximum length L of the top-view pattern of the pillar structures 102 to a gap S2 between the adjacent pillar structures 102 ranges from 0.2 to 0.4, which effectively enhances the intensity of the Raman signal and facilitates pathogen screening in a convenient and rapid way. In this embodiment, the maximum length L of the top-view pattern of the pillar structures 102 refers to the distance between the two furthest points on the top-view pattern of the pillar structures 102. The shape of the pillar structures 102 may be a column or a square column, but the disclosure is not limited thereto, and the shape of the pillar structures 102 is not limited to the shape shown in FIG. 1 and FIG. 2.

The target-analyte linking substances 104 are disposed on the pillar structures 102. The target-analyte linking substances 104 refer to linking substances that may be combined with the target analyte. For example, the target-analyte linking substances 104 may include an antibody, and the target analyte may include an antigen (e.g., a virus that causes COVID-19). In some embodiments, the target-analyte linking substances 104 are linked to the pillar structures 102 via linkers (not shown in the drawings). In some embodiments, the linkers are, for example, Thiol-PEG-Hydrazide (SH-PEG-HZ), but the present disclosure is not limited thereto. In some embodiments, although they are not shown in FIG. 1 and FIG. 2, the target-analyte linking substances 104 may also be disposed on the substrate 100.

In this embodiment, the antibody is an example of the target-analyte linking substances 104, and the antigen is an example of the target analyte, but the present disclosure is not limited thereto. As long as the target-analyte linking substances 104 and the target analyte are respectively one and the other of the binding pair, it falls within the scope of the present disclosure. For example, the binding pair may be a receptor-ligand, antibody-antigen, DNA-RNA, DNA-protein, RNA-protein, or complementary nucleic acid pair.

Based on the above embodiment, it can be seen that in the detection substrate 10 of SERS, since the ratio of the maximum length L of the top-view pattern of the pillar structures 102 to the gap S2 between the adjacent pillar structures 102 ranges from 0.2 to 0.4, the intensity of the Raman signal is enhanced effectively, and the pathogen screening may be facilitated in a convenient and rapid way.

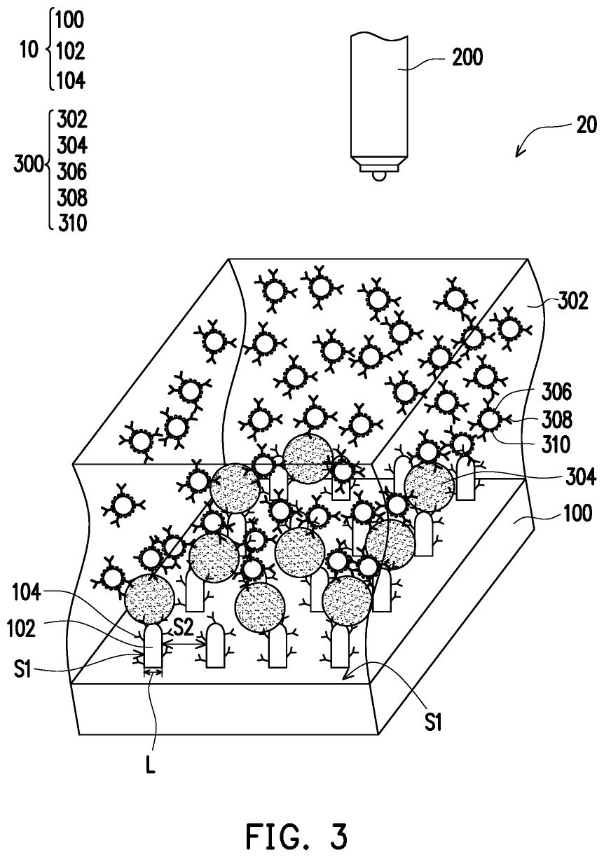

FIG. 3 is a schematic diagram of a detection system of SERS according to an embodiment of the present disclosure.

In FIG. 1 to FIG. 3, a detection system 20 includes a Raman spectrometer 200, a detection substrate 10, and a liquid sample 300. The Raman spectrometer 200 emits light (for example, laser light) for detection. For the detection substrate 10, reference may be made to the description of the foregoing embodiment, and thus its description is omitted here.

The liquid sample 300 includes a liquid solution 302, a sample 304, a plurality of particles 306, a plurality of target-analyte linking substances 308, and a plurality of Raman tags 310. The liquid solution 302 is, for example, a physiological solution, such as nasopharyngeal secretions, saliva, blood, or urine. The sample 304 is in the liquid solution 302. The sample 304 may include at least one of a target analyte and a non-target analyte. In some embodiments, the sample 304 may include an antigen (e.g., a virus that causes COVID-19), but the present disclosure is not limited thereto.

The particles 306 are in the liquid solution 302. The particles 306 may be nanoparticles. The particles 306 may be Raman active particles, the particles that enhance the Raman signal. The material of the particles 306 is, for example, silver, gold, platinum, nickel, copper, or a combination thereof.

The target-analyte linking substances 308 are provided on the particles 306. The target-analyte linking substances 308 refer to linking substances that may be combined with the target analyte. In some embodiments, the target-analyte linking substances 104 and the target-analyte linking substances 308 may respectively include antibodies, and the target analyte may include an antigen (e.g., a virus that causes COVID-19). In some embodiments, the target-analyte linking substances 104 may be different from the target-analyte linking substances 308. For example, the target-analyte linking substances 104 and the target-analyte linking substances 308 may be different antibodies. In some embodiments, the target-analyte linking substances 104 and the target-analyte linking substances 308 are linked to different binding sites on the target analyte. For example, the binding sites on the target analyte may be the recognition sites on the antigen, and the target-analyte linking substances 104 and the target-analyte linking substances 308 can be linked to different recognition sites of the target analyte (e.g., an antigen). In some embodiments, the target-analyte linking substances 308 can be linked to the particles 306 via linkers (not shown in the drawings). In some embodiments, the linkers are, for example, Thiol-PEG-Hydrazide (SH-PEG-HZ), but the present disclosure is not limited thereto.

In some embodiments, as shown in FIG. 3, when the sample 304 is the target analyte, the sample 304 is bound to the target-analyte linking substances 104 on the pillar structures 102 and the target-analyte linking substances 308 on the particles 306. In other embodiments, under conditions where the sample 304 is not the target analyte, the sample 304 is not bound to the target-analyte linking substances 104 on the pillar structures 102 and the target-analyte linking substances 308 on the particles 306.

In this embodiment, the antibody is an example of the target-analyte linking substances 308, and the antigen is an example of the target analyte, but the present disclosure is not limited thereto. As long as the target-analyte linking substances 308 and the target analyte are respectively one and the other of the binding pair, it falls within the scope of the present disclosure. For example, the binding pair may be a receptor-ligand, antibody-antigen, DNA-RNA, DNA-protein, RNA-protein, or complementary nucleic acid pair.

The Raman tags 310 are provided on the particles 306. The Raman tags 310 may be adapted to generate the Raman signal. In some embodiments, the Raman tags 310 are, for example, 4-mercaptobenzoic acid (4-MBA), but the present disclosure is not limited thereto.

Based on the above embodiment, it can be seen that in the detection system 20 of SERS, since the ratio of a maximum length L of the top-view pattern of the pillar structures 102 to a gap S2 between the adjacent pillar structures 102 ranges from 0.2 to 0.4, the intensity of the Raman signal is enhanced effectively, and the pathogen screening may be facilitated in a convenient and rapid way. In addition, the detection system 20 of SERS provides a solution of sandwich capture technique. That is, the target analyte is captured by linking the target-analyte linking substances 104 on the pillar structures 102 and the target-analyte linking substances 308 on the particles 306 respectively to the target analyte, which increases specificity and sensitivity. In this way, when the sample 304 includes the target analyte, the target analyte is bound to the target-analyte linking substances 104 on the pillar structures 102 and the target-analyte linking substances 308 on the particles 306.

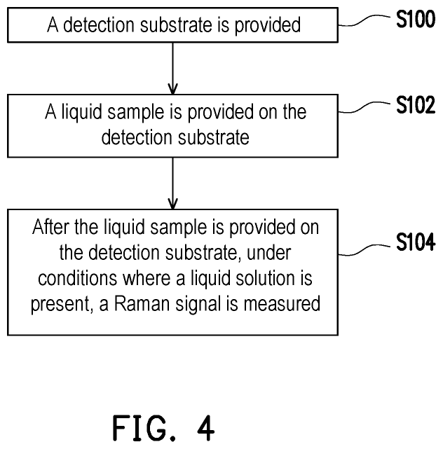

FIG. 4 is a flowchart of a detection method of SERS according to an embodiment of the present disclosure.

Please refer to FIG. 1 to FIG. 4. A detection substrate is provided in step S100. In some embodiments, the detection substrate may be the detection substrate 10 of the above embodiments, but the present disclosure is not limited thereto. In some embodiments, the ratio of a maximum length L of the top-view pattern of pillar structures 102 to a gap S2 between adjacent pillar structures 102 ranges from 0.2 to 0.4.

Then, a liquid sample 300 is provided on the detection substrate 10 in step S102. For the liquid sample 300, reference may be made to the description of the foregoing embodiment, as the same description is not repeated herein.

After the liquid sample 300 is provided on the detection substrate 10, under conditions where a liquid solution 302 is present, a Raman signal of the sample 304 is measured in step S104. That is, after the liquid sample 300 is provided on the detection substrate 10, the Raman signal of the sample 304 may be measured without cleaning, so that the pathogen screening is carried out in a convenient and rapid way. In some embodiments, the Raman signal of the sample 304 can be measured by the Raman spectrometer 200 in FIG. 3.

For example, under conditions where the intensity of the Raman signal of the sample 304 reaches a specific Raman-signal intensity, it is determined that the sample 304 includes a target analyte (e.g., the virus that causes COVID-19), and under conditions where the intensity of the Raman signal of the sample 304 does not reach the specific Raman-signal intensity, it is determined that the sample 304 does not include the target analyte.

Based on the foregoing embodiments, it can be known that in the foregoing detection method of SERS, the target-analyte linking substances 104 on the pillar structures 102, the target-analyte linking substances 308 on the particles 306, and the sample 304 may undergo a pot reaction. Under conditions where the sample 304 includes the target analyte, the target analyte is bound to the target-analyte linking substances 104 on the pillar structures 102 and the target-analyte linking substances 308 on the particles 306. In this way, as the particles 306 combined with the target object are close to the hot spot above the detection substrate 10, a clear Raman signal is generated by the Raman tags 310 on the particles 306 to perform the pathogen screening. In some embodiments, before the target analyte bound to the particles 306 is combined with the target-analyte linking substances 104 on the substrate 10, as long as the particles 306 bound to the target analyte are close to the hot spot above the detection substrate 10, a clear Raman signal may be generated by the Raman tags 310 on the particles 306, which further speeds up the process of the pathogen screening. In addition, since the SERS measurement is highly related to distance, the particles 306 that are not bound to the target object are suspended on the surface of the liquid sample 300 and thus do not affect the measurement result. In this way, after the liquid sample 300 is provided on the detection substrate 10, the Raman signal of the sample 304 may be measured under conditions where the liquid solution 302 is present (for example, without cleaning), and therefore, the pathogen screening may be carried out in a convenient and rapid way without being affected by background noise (e.g., the particles that are not bound to the target analyte).

In summary, in the inspection substrate and the inspection system of SERS in the above embodiments, since the ratio of the maximum length of the top-view pattern of the pillar structures to the gap between the adjacent pillar structures ranges from 0.2 to 0.4, the intensity of the Raman signal may be enhanced effectively, and the pathogen screening may be facilitated in a convenient and rapid way. In addition, the detection system of SERS in the above embodiment provides a solution of sandwich capture technique that increases specificity and sensitivity. Moreover, in the detection method of SERS in the above embodiment, after providing the liquid sample on the detection substrate, the Raman signal of the sample may be measured under conditions where the liquid solution is present, so that the pathogen screening may be carried out in a convenient and rapid way without being affected by background noise.

Although the present disclosure has been disclosed in the above embodiments, they are not intended to limit the present disclosure. Anyone with ordinary knowledge in the technical field can make some changes and modifications without departing from the spirit and scope of the present disclosure. The scope of protection of the present disclosure shall be subject to those defined by the claims attached.

What is claimed is:

1. A detection substrate of surface-enhanced Raman scattering, comprising:
a substrate;
a plurality of pillar structures, disposed on the substrate and having a Raman active surface, wherein a ratio of a maximum length of a top-view pattern of the pillar structures to a gap between the adjacent pillar structures ranges from 0.2 to 0.4; and
a plurality of target-analyte linking substances, disposed on the pillar structures.

2. The detection substrate of surface-enhanced Raman scattering according to claim 1, wherein a material of the substrate comprises plastic.

3. The detection substrate of surface-enhanced Raman scattering according to claim 2, wherein the plastic comprises polycarbonate.

4. The detection substrate of surface-enhanced Raman scattering according to claim 1, wherein the substrate and the pillar structures are integrally formed.

5. The detection substrate of surface-enhanced Raman scattering according to claim 1, wherein the pillar structures are ordered pillar structures.

6. The detection substrate of surface-enhanced Raman scattering according to claim 1, wherein the target-analyte linking substances comprise an antibody.

7. A detection system of surface-enhanced Raman scattering, comprising:
a Raman spectrometer;
a detection substrate, wherein the detection substrate comprises:
a substrate;
a plurality of pillar structures, disposed on the substrate and having a Raman active surface, wherein a ratio of a maximum length of a top-view pattern of the pillar structures to a gap between the adjacent pillar structures ranges from 0.2 to 0.4; and
a plurality of first target-analyte linking substances, disposed on the pillar structures; and
a liquid sample, comprising:
a liquid solution;
a sample, located in the liquid solution;
a plurality of particles, located in the liquid solution;
a plurality of second target-analyte linking substances, disposed on the particles; and
a plurality of Raman tags, provided on the particles.

8. The detection system of surface-enhanced Raman scattering according to claim 7, wherein a material of the substrate comprises plastic.

9. The detection system of surface-enhanced Raman scattering according to claim 7, wherein the substrate and the pillar structures are integrally formed.

10. The detection system of surface-enhanced Raman scattering according to claim 7, wherein the pillar structures are ordered pillar structures.

11. The detection system of surface-enhanced Raman scattering according to claim 7, wherein the first target-analyte linking substances are different from the second target-analyte linking substances.

12. The detection system of surface-enhanced Raman scattering according to claim 11, wherein the first target-analyte linking substances and the second target-analyte linking substances are linked to different binding sites on a target analyte.

13. The detection system of surface-enhanced Raman scattering according to claim 7, wherein the first target-analyte linking substances and the second target-analyte linking substances respectively comprise an antibody, and a target analyte comprises an antigen.

14. The detection system of surface-enhanced Raman scattering according to claim 7, wherein the particles comprise nanoparticles.

15. The detection system of surface-enhanced Raman scattering according to claim 7, wherein the particles comprise Raman active particles.

16. A detection method of surface-enhanced Raman scattering, comprising:
providing a detection substrate, wherein the detection substrate comprises:
a substrate;
a plurality of pillar structures, disposed on the substrate and having a Raman active surface; and
a plurality of first target-analyte linking substances, disposed on the pillar structures;
providing a liquid sample on the detection substrate, wherein the liquid sample comprises:
a liquid solution;
a sample, located in the liquid solution;
a plurality of particles, located in the liquid solution;
a plurality of second target-analyte linking substances, disposed on the particles; and
a plurality of Raman tags, provided on the particles; and
after providing the liquid sample on the detection substrate, measuring a Raman signal of the sample under conditions where the liquid solution is present.

17. The detection method of surface-enhanced Raman scattering according to claim 16, wherein after providing the liquid sample on the detection substrate, measuring the Raman signal of the sample without cleaning.

18. The detection method of surface-enhanced Raman scattering according to claim 16, wherein
under conditions where an intensity of the Raman signal of the sample reaches a specific Raman-signal intensity, determining that the sample comprises a target analyte, and
under conditions where the intensity of the Raman signal of the sample does not reach the specific Raman-signal intensity, determining that the sample does not comprise the target analyte.

19. The detection method of surface-enhanced Raman scattering according to claim 16, wherein a ratio of a maximum length of a top-view pattern of the pillar structures to a gap between the adjacent pillar structures ranges from 0.2 to 0.4.

20. The detection method of surface-enhanced Raman scattering according to claim 16, wherein a material of the substrate comprises plastic.
